(19) United States
(12) Patent Application Publication
(10) Pub. No.: US 2010/0211670 A1
(43) Pub. Date: Aug. 19, 2010

(54) SYSTEM FOR MONITORING PRODUCTION OPERATIONS

(75) Inventor: Rick Caldwell, Normal, IL (US)

Correspondence Address: BAKER & DANIELS LLP, 300 NORTH MERIDIAN STREET, SUITE 2700, INDIANAPOLIS, IN, 46204, US

(73) Assignee: SCADAware, Bloominton, IN (US)

(21) Appl. No.: 12/371,816

(22) Filed: Feb. 16, 2009

(51) Int. Cl. G06F 15/16; G06F 17/30

(52) U.S. Cl. 709/224; 707/E17.01; 709/204

(57) ABSTRACT

A system for monitoring production operations includes an operator box located at a workstation and having a plurality of manual input devices configured for manual activation by an operator, a corresponding plurality of status indicators, each status indicator being configured to provide an indication of the operational status of the workstation, and a communications port configured to facilitate communication between the operator box and a network. The system also includes a computing device coupled to network to receive data from a machine controller coupled to the network and data from the operator box, and to store that data in a database of records reflecting historical performance of the system.

### FIELD OF THE INVENTION

The present disclosure generally relates to systems for monitoring equipment operation and production status, and more specifically to systems that provide communication, control, and monitoring functions for industrial equipment operations.

### BACKGROUND

In industrial settings such as manufacturing environments it is desirable to monitor the operation of equipment and provide a means of communication among employees regarding the status of such equipment. When operating a factory production line, for example, the smooth and continuous operation of the line is accomplished by coordinating the activities of and responding to the needs of operators at various stations on the line. For example, the operators need an efficient way to communicate with other employees when the equipment they operate has malfunctioned or otherwise needs attention or may soon need attention. Often the equipment operator cannot leave the station to provide information to others because the equipment must operate continuously. In many situations, the equipment operators use parts or materials (e.g., when assembling items) and the local supply of those parts or materials needs to be periodically replenished. Again, it is generally not feasible for these operators to leave their station to obtain more supplies or inform another of the need for more supplies. The need for additional resources must also be communicated to others in an efficient manner. Any system for addressing these communication needs must take into account the noise, obstructed views, and other impediments to communication typically present in such industrial environments.

Moreover, the performance of equipment used in such situations may be enhanced by monitoring the operation of the equipment and making adjustments to the manner in which it is operated or maintained based on its historical performance. By studying the record of the equipment's operation, it is possible to identify problems such as frequent malfunctions, which may lead to the replacement of the equipment with other equipment more suitable for the task. It is further possible to identify throughput trends that correspond to other activities in the environment. In this manner, a facility operator can study the environment as a whole and make changes to the various stations making up the environment to achieve a more efficient operation.

One type of system for providing communication (but not equipment monitoring) in an industrial setting is an “Andon system.” Pioneered by Toyota as part of its quality control methodology, a typical Andon system permits a worker to alert management, maintenance or other workers of a quality issue or a problem that may affect the production line. When the worker identifies, for example, a part shortage, a defect, a tool malfunction, or a safety issue, the worker manually generates an alert by using a pull cord or pushing a button at the work station. This action then generates the alert, typically in the form of a signal light of a particular color, on a signboard mounted on a mast to indicate which work station has a problem and the general nature of the problem.

Some Andon systems are configured to generate alerts automatically. For example, a sensor may be mounted to detect the level of a parts supply. The sensor may detect when the supply is reduced to a level requiring replenishment and output a signal. By facilitating communication between the sensor and the Andon system, this output signal may automatically cause the illumination of an alert light of a particular color. In fact, in some Andon systems, the alert, whether manually or automatically generated, may also cause the automatic shut down of the production line.

Another feature of some Andon systems is the ability to log alerts in a database for later analysis. The logged data may include a description of the alert and the location of the source of the alert. Some Andon systems further include audio alerts in addition to or instead of the visual alerts described above.

Andon systems address many of the communication needs in industrial settings, and are generally effective in permitting employees to quickly call for help without leaving their workstation. However, such systems are typically expensive to install and inflexible. Moreover, it is generally expensive and difficult to integrate the dedicated electronics of an Andon system with other systems in the industrial setting. Additionally, the basic information stored by some Andon systems is of limited value for accomplishing process improvement.

### SUMMARY

The present disclosure provides a system for monitoring production operations including an operator box located at a workstation and having a plurality of manual input devices configured for manual activation by an operator. The box further includes a corresponding plurality of status indicators, each status indicator being configured to provide an indication of the operational status of the workstation, and a communications port configured to facilitate communication between the operator box and a network. A facility computing device is coupled to network to receive data from a machine controller at the workstation which operates equipment at the workstation, and from the operator box. The facility computing device stores that data in a database of records reflecting historical performance of the system and provides access to the database via a browser.

### BRIEF DESCRIPTION OF THE DRAWINGS

The above-mentioned aspects of the present teachings and the manner of obtaining them will become more apparent and the teachings will be better understood by reference to the following description of the embodiments taken in conjunction with the accompanying drawings, wherein:

FIG. 1 is a block diagram of a system according to the present disclosure; and

FIG. 2 is a block diagram of the operator box depicted in FIG. 1.

Corresponding reference characters indicate corresponding parts throughout the several views.

### DETAILED DESCRIPTION

The embodiments of the present teachings described below are not intended to be exhaustive or to limit the teachings to the precise forms disclosed in the following detailed description. Rather, the embodiments are chosen and described so that others skilled in the art may appreciate and understand the principles and practices of the present teachings.

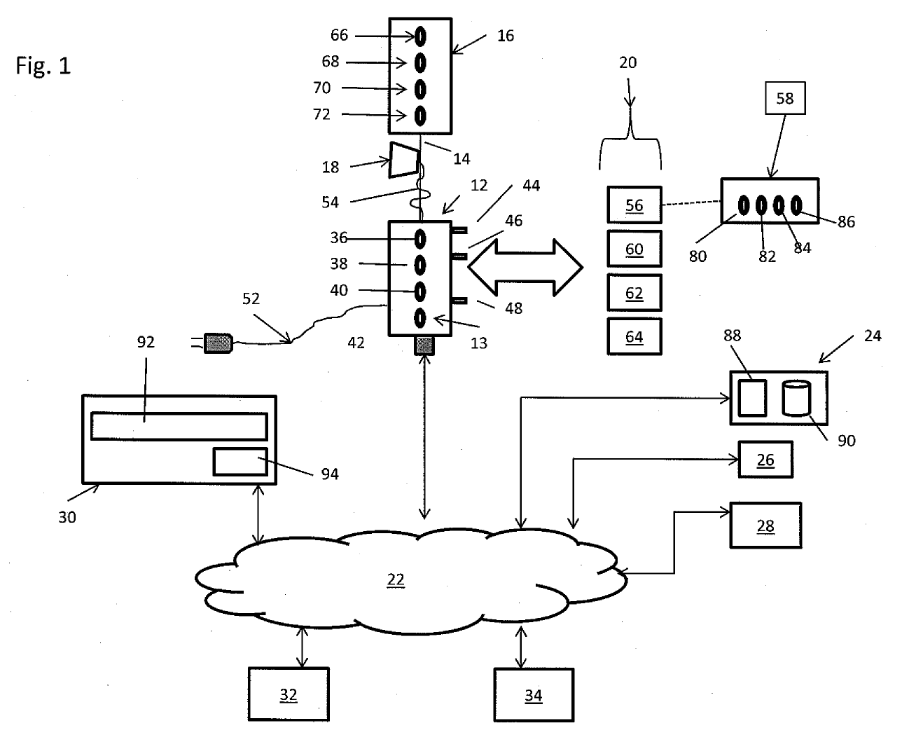

Referring now to FIG. 1, a system 10 according to the present disclosure generally includes an operator box 12, a mast 14 configured to support a lighting fixture 16 and an audible alert device 18, a plurality of input devices collectively referred to by the designation 20, and a network 22 coupled to a local computing device 24, a machine controller 26, a facility computing device 28, a display device 30, a remote server 32 and a remote computing device 34. Operator box 12 generally includes a housing 13 to which is mounted a plurality of manual input devices or buttons 36, 38, 40, 42, a plurality of USB ports 44, 46, a serial port 48, a network I/O port 50, a power cord 52 and a cable 54 coupled to lighting fixture 16 and audible alert device 18. Mast 14 is shown attached to operator box 12. Mast 14, may however, be mounted separate from operator box 12. As is further described below, the plurality of input devices 20 may include a remote control transceiver 56 configured to receive inputs from a remote control 58, a bar code reader 60, a Human Machine Interface (“HMI”) 62, and a badge reader 64.

In one embodiment of the present disclosure, operator box 12 includes four push buttons 36, 38, 40, 42 as shown. It should be understood, however, that more or fewer buttons may be used depending upon the application. Further, while push buttons are described herein, any suitable input device may be substituted for the push buttons such as switches, a touch pad, a keyboard, etc. Housing 13 may be configured to provide a NEMA 12/13 rating (dust proof), a NEMA 4 rating (waterproof), or other NEMA ratings that are suitable for a particular environment such as a harsh industrial setting. Operator box 12 is configured to control a plurality of lights 66, 68, 70, 72 mounted to mast 14 as shown in FIG. 1. In one embodiment, the plurality of lights includes a red light 66, a yellow light 68, a green light 70 and a blue light 72.

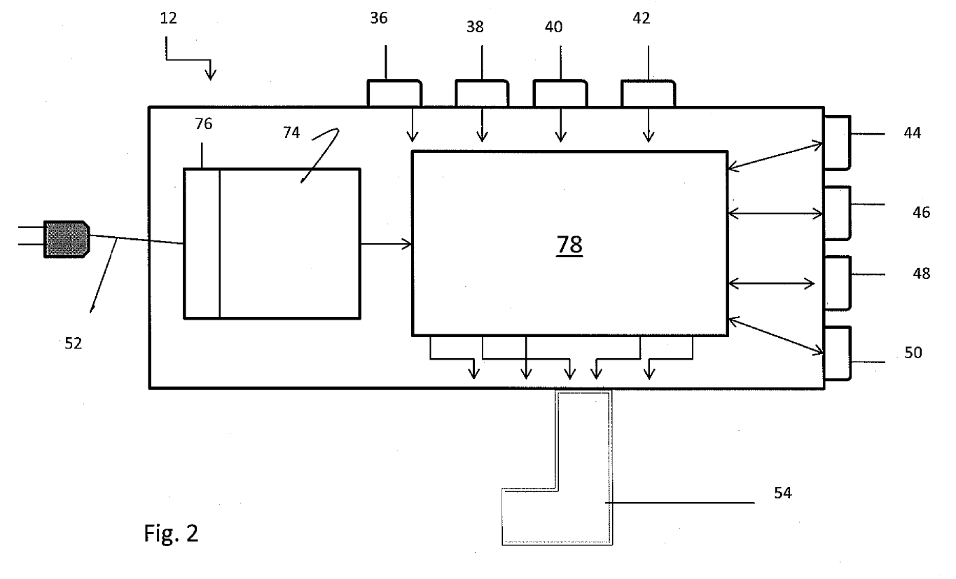

Referring to FIG. 2, operator box 12 further includes a built-in switching power supply 74 including a power conditioning circuit 76 that is adapted to receive source power through power cord 52 at typical North American voltages of 110-120 volts at 60 Hz or typical foreign voltages of 220-240 volts at 50 Hz. Power conditioning circuit 76 converts the power source to a standard output power (e.g., 24 VDC). Operator box 12 further includes a built-in controller 78 that permits logic modification. In other words, controller 78 may be programmed to provide a variety of different lighting behaviors depending upon the needs of the facility. In one embodiment, controller 78 is a single board computing device that uses a Linux operating system. For example, controller 78 may include an ARM chip, two Ethernet ports that function as a switching hub, one or more USB ports, a serial port, 18 digital inputs, and 18 digital outputs. As is further explained herein, some of the inputs are used for push buttons 36, 38, 40, 42 and some of the outputs are used for lights 66, 68, 70, 72. In other embodiments, some of the inputs and outputs are used to connect to relay contacts, etc. of legacy systems that do not include Ethernet or USB ports.

As shown, controller 78 receives input signals from buttons 36, 38, 40, 42 and provides output signals to cable 54 which control the operation of lighting fixture 16 and audible alert device 18 as is further described below. Controller 78 also communicates with the various external devices depicted in FIG. 1 through optional USB ports 44, 46, serial port 48, and network I/O port 50.

In general, basic functions of operator box 12 include permitting the operator to provide input to system 10 regarding the status of the operator's station and to communicate that status to others in the facility. In one embodiment of system 10, button 36 is designated a red button and corresponds to red light 66 of lighting fixture 16. Similarly, button 38 is designated yellow and corresponds to yellow light 68, button 40 is designated green and corresponds to green light 70, and button 42 is designated blue and corresponds to blue light 72. It should be understood, however, that any of a variety of different designations may be associated with buttons 36, 38, 40, 42 depending upon the application.

In one embodiment of system 10, controller 78 is programmed to interpret a first activation of button 36 as a command to supply power to the red light 66 such that it is flashed on and off. A second activation of button 36 is interpreted as a command to cause red light 66 to remaining illuminated continuously. A third activation of button 36 is interpreted as a command to deactivate red light 66. As is further described below, controller 78 is programmed to perform similar functions based on activation of the other buttons 38, 40, 42 on operator box 12. In general, red light 66 may indicate a station shut-down condition, yellow light 68 may indicate a problem that needs to be addressed but has not yet caused a station shut-down, green light 70 may indicate that the station is operating normally, and blue light 72 may indicate a need for additional supplies or materials. Of course, other meanings may be assigned to lights 66, 68, 70, 72. Also, when red light 66 is on, regardless of its lighting condition (i.e., continuous or flashing), and a button 38, 40 corresponding to either yellow light 68 or green light 70 is depressed, the light 68, 70 corresponding to the depressed button 38, 40 will begin flashing and the red light will turn off. Similarly, if yellow light 68 is on (either continuously or flashing) and button 40 corresponding to green light 70 is depressed, green light 70 will begin flashing and yellow light 68 will turn off.

In one embodiment of the disclosure, a flashing red light 66 caused by a first actuation of button 36 indicates to others in the facility that the station associated with red light 66 is non-operational. When the appropriate person sees the flashing red light 66, that person (“the responder”) goes to the station requiring attention. The responder should immediately actuate button 36 again to cause red light 66 to illuminate continuously. The continuous illumination of red light 66 indicates that the station is down, but a responder has responded and is in the process of addressing the problem at the station. In this way, other potential responders do not waste their time responding to the station when the problem is already being addressed.

In embodiments of system 10 including audible alert device 18, the communication function of lights 66, 68, 70, 72 may be augmented by operation of device 18. For example, controller 78 may be configured to respond to a first actuation of button 36 by not only causing red light 66 to flash, but by activating audible alert device 18, which may be a horn, buzzer, bell, or other sound producing mechanism. Audible alert device 18 may sound continuously or turn on and off, in synch with red light 66 or otherwise. Audible alert device 18 helps to draw attention to the fact that the status of the station has changed, and may cause a responder looking in a different direction or with an obstructed view of lighting fixture 16 to more quickly ascertain the status of the station. It should be understood that different tones or activation patterns may be used to indicate different status conditions. For example, a siren-type sound may be produced with a red light while a less urgent sounding continuous tone may be produced with a yellow light. It should be further understood that a central audible alert device may be used instead of providing an audible alert device 18 for each station. In such an embodiment, operator box 12 may provide a control signal to the central audible alert device via a network according to the principles described below. When a central audible alert device is used, display device 30 should be provided to indicate which of the stations utilizing the central audible alert device has caused its activation.

As indicated above, operator box 12 includes network I/O port 50. Port 50 may be coupled to a full Ethernet switching hub (not shown) for connecting operator box 12 to network 22 where network 22 is an Ethernet. It should be understood that while a single network 22 is depicted in FIG. 1, operator box 12 may be coupled via port 50 (or ports 44, 46, 48) to more than one network, which may include cellular telephone networks (directly or indirectly), the internet, local area networks, wide area networks, etc. Controller 78 may be configured to generate a notification message (in addition to the visual and audio alerts discussed above) for a particular responder or group of responders, depending upon the status of the station. The message may be sent to a preferred responder through port 50 and over network 22. The message may be a pager call, text message, email, etc. The receiving device may be a pager, a cellular telephone, a personal digital assistant, a laptop computer, a personal computer, or other device capable of receiving messages of some kind. Of course, the message may be sent to multiple receiving devices for a single responder or multiple responders. The notification protocol may vary widely and may be defined by the software operating on controller 78. For example, a hierarchy of responders may be defined for certain stations or certain status situations.

Controller 78 of operator box 12 may also be configured for remote access to permit remote status monitoring or remote configuration. Referring again to FIG. 1, in embodiments where network 22 includes a public network such as the internet, remote server 32 coupled to network 22 may facilitate responder notification messaging via one of the modes of communication described above, while remote computing device 34 facilitates connection to operator box 12 remotely using a conventional browser to view the operational information logged in a database located, for example, on facility computing device 28, which typically runs the software package designed to implement many of the monitoring, data storage and reporting functions of system 10. A commercial embodiment of this software sold under the name StatusWatch® by SCADAware, Inc. of Bloomington, Ill. In this manner, the responder may be able to clear some status conditions remotely, or at least acquire some information about the operation of operator box 12 prior to the status condition leading to the message before physically responding to the notification. In such an embodiment, controller 78 may further include a built-in web server (not shown) for remote interrogation, configuration and control as described herein. It should be further understood that the functionality of controller 78 (e.g., the interpretation of inputs from buttons 36, 38, 40, 42 or the manner in which notifications are sent) may be configured remotely.

Still referring to FIG. 1, USB ports 44, 46 of operator box 12 are provided to facilitate expandability of the functionality of the box. While two USB ports are shown, more or fewer ports may be provided consistent with the teachings of the present disclosure. In one embodiment of system 10, the functionality of operator box 12 is expanded using one or more of input devices 20. For example, barcode reader 60 may be connected to one of USB ports 44, 46 to permit the input of various types of bar-coded data. In one embodiment, the station operator or other personnel uses a problem description sheet with a plurality of different bar codes, each corresponding to a different problem potentially associated with the station. Whenever a button 36, 38, 40, 42 on operator box 12 is depressed, the operator or responder uses barcode reader 60 to scan in the code best representing the problem associated with that activation of a button. In this manner, a basic description of the various problems and situations associated with each button 36, 38, 40, 42 may be stored in a database or communicated over network 22 for future analysis. Such problems may include electrical problems, tool malfunctions, etc.

Alternatively, HMI 62 may be coupled to operator box 12 via one of USB ports 44, 46. In one embodiment, HMI 62 includes a touch screen or other input device such as a keyboard, etc. that permits the operator to input information or commands to operator box 12. In this manner, the operator may configure different monitoring options or provide problem descriptions for logging in the database in association with different events such as activation of a button 36, 38, 40, 42. For example, when an operator pushes one of buttons 36, 38, 40, 42 on operator box 12, the operator may also select a problem description on the HMI to provide a reason description for pushing the button.

Additionally, badge reader 64 may be coupled to operator box 12 via a USB port 44, 46 to permit monitoring of the personnel interacting with the station. For example, at the beginning and end of a work shift, the station operators may swipe an identification badge through reader 64 to record the time during which the personnel are operating the station. Also, when a responder responds to an alert, the responder may swipe his or her badge through reader 64 to create a record of the person who actually responded to the alert. This also provides information about the elapsed time between the generation of the alert and the arrival of the responder. When the responder resolves the problem associated with the alert, the responder may again swipe his or her badge through reader 64 to provide information about the time required to resolve the problem. In this manner, the performance of responders in terms of responding to alerts and resolving the associated problems may be tracked and evaluated to identify trends and opportunities for improvement.

In another embodiment of the disclosure, remote control 58 is coupled through receiver 56 to a USB port 44, 46 of operator box 12. Remote control 58 includes a plurality of buttons 80, 82, 84, 86 that correspond in function to buttons 36, 38, 40, 42. Activation of buttons 80, 82, 84, 86 causes remote control 58 to emit signals (IR, RF, etc.) to receiver 56, which in turn are transmitted to operator box 12 through USB port 44, 46. Use of buttons 80, 82, 84, 86 of remote control 58 instead of buttons 36, 38, 40, 42 may be desirable in situations where the station operator is at certain times physically separated from operator box 12. For example, some station operators regularly perform assembly operations on large equipment that require the operator to climb onto or crawl under the equipment. These operators may carry remote control 58 and signal a problem through use of buttons 80, 82, 84, 86 without having to remove themselves from their current position and walk over to operator box 12 to depress the buttons 36, 38, 40, 42.

In other embodiments of the disclosure, the plurality of operator boxes 12 associated with the plurality of stations in a facility are in communication via network 22 with facility computing device 28. Facility computing device 28 may operate using an industry protocol (such as Modbus/TCP) defined such that activation of a button 36, 38, 40,42 on an operator box 12 causes facility computing device 28 to provide an input to one or more machine controllers 26 in addition to activating a light 66, 68, 70, 72 on lighting fixture 16. It should be understood that while only one machine controller 26 is depicted in FIG. 1, many machine controllers 26 may be utilized throughout the facility. Moreover, in some embodiments, machine controllers 26 are coupled to network 22 for communication with facility computing device 28 (and/or local computing device 24). By communicating with operator box 12 and local computing device 24, one or more machine controllers 26 may, for example, control a conveyor, indexing device, or other equipment associated with the line serviced by the stations. In this manner, based on the current status of the plurality of stations, machine controllers 26 may cause the assembly line to stop or go or move at a particular speed. For example, machine controller 26 may stop the assembly line upon detecting a red button alert associated with any one of the plurality of stations.

Facility computing device 28 executes production monitoring software 88 such as the StatusWatch® mentioned above. According to the principles described herein, one skilled in the art could further configure system 10 for interfacing with various types of Supervisor Control and Data Acquisition software packages. Facility computing device 28 may function as a central controlling device for the plurality of operator boxes 12 and a central repository of information collected from the boxes 12. Computing device 28 may communicate with the boxes 12 over network 22 and log each input to the box 12 (e.g., from buttons 36, 38, 40, 42, remote control 58, HMI 62, barcode reader 60, badge reader 64, etc.) as a time stamped record of the input in a database 90, such as an Oracle or SQL database, either resident on computing device 28 or some other machine coupled to network 22. The record may be associated with the person (operator or responder) related to the event, the current operating status of the equipment, etc.

Software 88 further permits custom report generation which facilitates reporting of the operation of a single station, a plurality of related stations, an entire production line, an entire facility, etc. Each station may be associated with a unique IP address if connected to an Ethernet 22. The user of local computing device 24 may define the station groupings for the reports, as well as the type of data to be included in the reports (up time, down time, time between events, etc.), which may be delivered over network 22 via a conventional web browser. Software 88 may then be executed by facility computing device 28 to interface with and control the operation of machine controllers 26 in the manner described above. By interfacing with facility computing device 28 via network 22 in this manner, operator boxes 12 and lighting fixtures 16 need not be hard wired to machine controllers 26. As such, the risk violating warranty conditions associated with machine controllers 26 may be avoided, station down time may be reduced, and a highly reliable, low cost communication and monitoring system may be quickly and easily installed in the facility.

It should also be understood that local computing device 24 may be coupled indirectly to machine controllers 26, which are configured to control the operation of the equipment associated with the various stations. Local computing device 24 may receive signals over network 22 representing the operation of the equipment from facility computing device 28, which communicates with machine controllers 26. In this manner, local computing device 24 can monitor the operation of the equipment as indicated by the operation of the associated machine controller 26, and log the various signals provided by machine controller 26. Typically, however, local computing device is used for manual data entry such as to note the reason for activation of one of the buttons 36, 38, 40, 42.

It should be understood that operator boxes 12 may be coupled to facility computing device 28 and/or local computing device 24 over network 22 via wireless access points mounted at various locations throughout the facility. The communications between operator boxes 12 and network 22 may be according to a proprietary protocol such as XBee to prevent unauthorized access to system 10 by wireless devices being operated by individuals outside the facility.

Finally, operator box 12 may be configured for operation with display device 30 as indicated above. Central display 30 (sometimes referred to as a “scoreboard”) includes an LED or LCD display 92 and a computing device 94. Computing device 94 may run an operating system such as Microsoft embedded XP. The present system may include a software application that runs on the display operating system and interfaces with production monitoring software 88 described above. The software application can cause display 92 to display information in any of a variety of different ways depending upon the input from monitoring software 88, which receives its inputs from operator boxes 12 or machine controllers 26.

While an exemplary embodiment incorporating the principles of the present teachings has been disclosed hereinabove, the present teachings are not limited to the disclosed embodiments. Instead, this application is intended to cover any variations, uses, or adaptations of the disclosed general principles. Further, this application is intended to cover such departures from the present disclosure as come within known or customary practice in the art to which this application pertains and which fall within the limits of the appended claims.

What is claimed is:

1. A system for monitoring the operation of equipment at a plurality of workstations in a facility, including:
a network;
an operator box located at a workstation and having a plurality of manual input devices configured for manual activation by an operator, a corresponding plurality of status indicators, each status indicator being configured to provide an indication having a predetermined meaning relating to the operational status of the workstation in response to activation of its corresponding manual input device, and a communications port configured to facilitate communication between the operator box and the network; and
a facility computing device coupled to the network and configured to execute software including instructions for communicating with a machine controller and the operator box over the network, instructions for generating machine controller records including information about operation of equipment controlled by the machine controller, instructions for generating operator box records including information about activation of the manual input devices, and instructions for writing the machine controller records and operator box records to a database associated with the facility computing device.

2. The system of claim 1, wherein the database is located on the facility computing device.

3. The system of claim 1, further including a local computing device coupled to the network for communication with the facility computing device and the operator box.

4. The system of claim 1, further including a display device coupled to the network for receiving status messages from the facility computing device.

5. The system of claim 4, wherein the status messages correspond to the indications provided by the status indicators, and the display device is configured to display the status messages.

6. The system of claim 1, further including a remote computing device coupled to the network for accessing machine controller records and operator box records in the database using a browser.

7. The system of claim 6, wherein the operator box further includes a web server.

8. The system of claim 1, further including a remote computing device coupled to the network for accessing the operator box over the network to monitor the activation of the manual input devices.

9. The system of claim 1, wherein the plurality of status indicators are lights mounted to a lighting fixture attached to the operator box by a mast.

10. The system of claim 1, further including a remote control transceiver configured to receive inputs from a remote control, the transceiver being coupled to a USB port on the operator box to provide the inputs from the remote control to the operator box.

11. The system of claim 10, wherein the remote control includes a plurality of buttons that correspond to the plurality of manual input devices on the operator box to permit the operator to activate the manual input devices from a location remote from the operator box.

12. The system of claim 1, further including a bar code reader coupled to the operator box through USB port to permit input of bar coded data into the operator box for storage in the database.

13. The system of claim 12, wherein the bar coded data includes a description of a reason for activating a manual input device.

14. The system of claim 1, further including a human machine interface coupled to the operator box, the human machine interface including a touch screen for data entry.

15. The system of claim 1, further including a badge reader coupled to the operator box through USB port, the badge reader being configured to read data from a badge identifying a responder to a workstation, and transmitting a time-stamped message with the identifying data to the operator box.

16. The system of claim 1, wherein the manual input devices are push buttons.

17. The system of claim 1, wherein the operator box includes a programmable controller that executes instructions to cause behaviors of the plurality of status indicators in response to activation of the manual input devices.

18. The system of claim 17, wherein the controller transmits messages to responders through the communications port over the network.

19. The system of claim 1, further including an audible alert device coupled to the operator box to provide an audible indication having a predetermined meaning relating to the operational status of the equipment at the workstation.

20. The system of claim 1, wherein the network includes a local area network and a network external to the facility.

21. The system of claim 1, wherein the facility computing device is coupled to the network via a wireless access point using a proprietary communications protocol.

22. A system for monitoring the operation of equipment at a plurality of workstations in a facility, including:
a network;
an operator box located at a workstation and having a plurality of manual input devices configured for manual activation by an operator, a corresponding plurality of status indicators, each status indicator being configured to provide an indication having a predetermined meaning relating to the operational status of the workstation in response to activation of its corresponding manual input device, and a communications port configured to facilitate communication between the operator box and the network; and
a first computing device coupled to the operator box over the network, the first computing device receiving status data from a machine controller coupled to the network, and operator box data from the operator box, the status data representing operational characteristics of equipment controlled by the machine controller, the operator box data representing activation of the manual input devices;
wherein the first computing device maintains a database of records including the status data and the operator box data and generates reports reflecting historical performance of the system.

23. An operator box for communicating the status of equipment at a workstation, including:
a plurality of buttons, each button corresponding to a different status condition of the equipment;
a plurality of lights, each light corresponding to one of the plurality of buttons;
a controller configured to activate the lights in response to activation of the buttons, thereby communicating the status of the equipment;
an internal power conditioning circuit configured to convert AC power to DC power; and
a communications port configured to couple to a network;
wherein the controller provides data to the network through the communications port describing the activation of the buttons.
